(19) United States
(12) Patent Application Publication
(10) Pub. No.: US 2008/0084834 A1
(43) Pub. Date: Apr. 10, 2008

(54) Multiplexed connection interface for multimedia serial data transmission

(76) Inventor: Zbigniew Stanek, Pirkkala (FI)

Correspondence Address: Hollingsworth & Funk, LLC;Suite 125, 8009 34th Avenue South, Minneapolis, MN, 55425, US

(21) Appl. No.: 11/544,257

(22) Filed: Oct. 9, 2006

(51) Int. Cl. H04B 1/58

(52) U.S. Cl. 370/284

(57) ABSTRACT

Systems and methods for serial data transmission having at least two different operating modes dependent on the connected signaling device. For instance, one exemplary method involves monitoring at least one line of an interface comprising at least four differential data line pairs, detecting signals indicative of the presence of a connected device at the interface, selecting one of a predefined set of operating modes dependent on detected signals on the monitored line(s), and receiving and/or transmitting signals on at least one of the differential data line pairs, where the received signals and/or signals to be transmitted are processed in combination or independently for each data line pair, dependent on the selected operating mode.

### FIELD OF THE INVENTION

The invention is related to a multiplexed connection interface for serial data transmission having at least two different operating modes dependent on the connected signaling device. In particular, this invention pertains to a combined connection interface for USB (universal serial bus) and HDMI (high definition multimedia interface) signaling, as well as a corresponding adapter, connector/plug, and operating method.

### BACKGROUND ART

A variety of devices and systems use digital serial interfaces for transmitting data, in particular voice and audio, video and other data across long connection distances (several meters) with very good signal quality. Such data require a high transmission bandwidth, and in a serial transmission scheme, also a high signal frequency to be transmitted across a cable.

There are different standards that are currently used for this kind of data transmission, such as USB (universal serial bus), DVI (digital visual interface), and HDMI (high definition multimedia interface), which are all based on differential signaling.

USB is widely used as a fast and comfortable interface in a range of devices, especially in the field of personal computers, but also e.g. for mobile devices such as data storage devices, media players, digital cameras, mobile phones, handheld computers and many more. The large popularity of USB makes it desirable to use this interface standard in a device for compatibility reasons. Still, video and audio data, in particular high definition video, cannot currently be transmitted via USB in a high quality. For example USB 2.0 cannot handle uncompressed HD bitrates. It can handle the compressed video bit rates only.

HDMI is mainly utilized for video and multimedia interfacing, that is, usually for connecting a video/audio source such as a receiver, DVD player or a set top box to a compatible display such as a TV or monitor. High quality video and audio is digitally transmitted via a single cable. DVI, which is common for computer monitors and graphic cards as an interface, is compatible to the video part of HDMI and may thus be used on the same connection interfaces with a suitable adapter. In contrast to HDMI, DVI doesn't support audio, i.e. is a video only interface.

An effective way to reduce transmission errors due to noise and electromagnetic interferences relies on differential signaling. Instead of a single line carrying the data to be transmitted, two parallel lines are used. One line carries the signal, while the other carries an inverse signal. At the reception site, both signals may be differentially combined to retrieve the (doubled) original signal as the difference of the signals. Since both lines receive approximately the same amount of external interference, noise and small variations of ground potential are eliminated in the resulting signal.

### SUMMARY

According to one aspect of the invention, a method is provided that comprises: detecting signals indicative of the presence of a connected device at an interface, said interface comprising at least four differential data line pairs; monitoring at least one line of said interface; selecting one of a predefined set of operating modes dependent on detected signals on said at least one monitored line; applying an operating voltage dependent on said selected operating mode to at least one transmitter and at least one receiver both connected to one of said differential line pairs; and receiving and/or transmitting signals on at least one of said differential data line pairs, wherein said received signals and/or signals to be transmitted are processed in combination or independently for each data line pair, dependent on said selected operating mode.

In some embodiments, the method may further comprise activating and/or deactivating at least one of said transmitters and receivers dependent on said selected operating mode.

In exemplary embodiments said predefined set of operating modes comprises at least a High Definition Multimedia Interface HDMI mode and/or a Universal Serial Bus USB mode.

Optionally, said HDMI mode may comprise a transmitter sub-mode and a receiver sub-mode.

In the HDMI transmitter sub-mode, the method may in some embodiments further comprise deactivating all receivers; and activating all transmitters connected to said differential line pairs. In the HDMI receiver sub-mode, the method may in some embodiments further comprise deactivating all transmitters; and activating all receivers connected to said differential line pairs.

In exemplary embodiments of the invention, a binary signal may be transmitted for selectively activating said transmitters and deactivating said receivers or for deactivating said transmitters and activating said receivers.

In some embodiments, the monitoring of at least one line further comprises receiving a signal sequence; and comparing said signal sequence to a stored signal sequence.

In these or other exemplary embodiments, monitoring of at least one line further comprises measuring a voltage level on at least one line; and determining whether said measured voltage level is within a predetermined voltage range.

The method may in some embodiments further comprise retrieving a stored default value for said operating voltage.

According to another aspect of the invention, an interface is provided that comprises: at least four transmitters and at least four receivers; at least four differential pairs of data lines, wherein each line pair is connected to outputs of one of said transmitters and inputs of one of said receivers; a detection unit capable of monitoring at least one line of said interface; at least one control line connected between said detection unit and said transmitters and receivers, and arranged to set an operating mode of each of said transmitters and receivers responsive to a signal detected on said at least one monitored line; and a processing unit connected to an input of said transmitters and to an output of said receivers, and arranged to process data received and/or transmitted via said four differential line pairs either combined or independently of each other, responsive to said detected signal.

In some embodiments, said detection unit comprises logic circuitry.

In further embodiments, said detection unit comprises a software module run on a processor or controller.

Exemplary embodiments may further comprise a control channel connected to said detection unit, wherein said detected signal may be a signaling sequence received on said control channel.

Some embodiments may further comprise a dedicated detection line connected to said interface, wherein said detected signal is a voltage level on said detection line.

The interface may in some embodiments be designed to match a plug or connector implemented in accordance with the HDMI specification v. 1.3.

In some embodiments, each two of said transmitters and receivers connected to one line pair are combined in a single transceiver unit, such as a single semiconductor chip.

According to another aspect of the invention, an adapter is provided comprising a first connector having at least eight input/output connections; at least one second connector having at least two input output connections; at least one pair of data lines adapted for differential signaling, said pair of data lines being connected between said first connector and said at least one second connector.

The adapter may in certain embodiments comprise four second connectors, each connected to a separate pair of data lines.

In exemplary embodiments, said first connector is implemented in accordance with the High Definition Multimedia Interface standard.

In exemplary embodiments, the at least one second connector is implemented in accordance with the Universal Serial Bus Standard.

According to further aspects of the invention, a mobile communication device may be provided, comprising a multiplexed connection interface, wherein said interface comprises at least four transmitters and at least four receivers; at least four differential pairs of data lines, wherein each line pair is connected to outputs of one of said transmitters and inputs of one of said receivers; a detection unit capable of monitoring at least one line of said interface; at least one control line connected between said detection unit and said transmitters and receivers, and arranged to set an operating mode of each of said transmitters and receivers responsive to a signal detected on said at least one monitored line; and a processing unit connected to an input of said transmitters and to an output of said receivers, and arranged to process data received and/or transmitted via said four differential line pairs either combined or independently of each other, responsive to said detected signal.

Also, for example a computer program product may be provided that is configured to perform the following steps when executed on a computer or processing unit: detecting the presence of a connected device at an interface, said interface comprising at least four differential data line pairs; monitoring a signal on at least one line of said interface; selecting one of a predefined set of operating modes dependent on said monitoring; and transmitting a signal for applying an operating voltage dependent on said monitored signal to at least one transmitter and at least one receiver circuit connected to said differential data line pairs.

Furthermore, a device may be provided that comprises means for detecting signals indicative of the presence of a connected device at an interface, said interface comprising at least four differential data line pairs; means for monitoring at least one line of said interface; means for selecting one of a predefined set of operating modes dependent on detected signals on said at least one monitored line; means for applying an operating voltage dependent on said selected operating mode to at least one transmitter and at least one receiver both connected to one of said differential line pairs; and means for receiving and/or transmitting signals on at least one of said differential data line pairs, wherein said received signals and/or signals to be transmitted are processed in combination or independently for each data line pair, dependent on said selected operating mode.

### BRIEF DESCRIPTION OF THE DRAWINGS

In the following, exemplary embodiments of the invention will be described in more detail with the aid of the accompanying figures, wherein

FIG. 1 is a partial schematic view of the circuitry of an exemplary connection interface according to the invention;

FIG. 2 is a illustration of connection possibilities using embodiments of the invention; and

FIG. 3a and 3b show flow charts of exemplary embodiments of the inventive method.

### DETAILED DESCRIPTION OF EXEMPLARY EMBODIMENTS

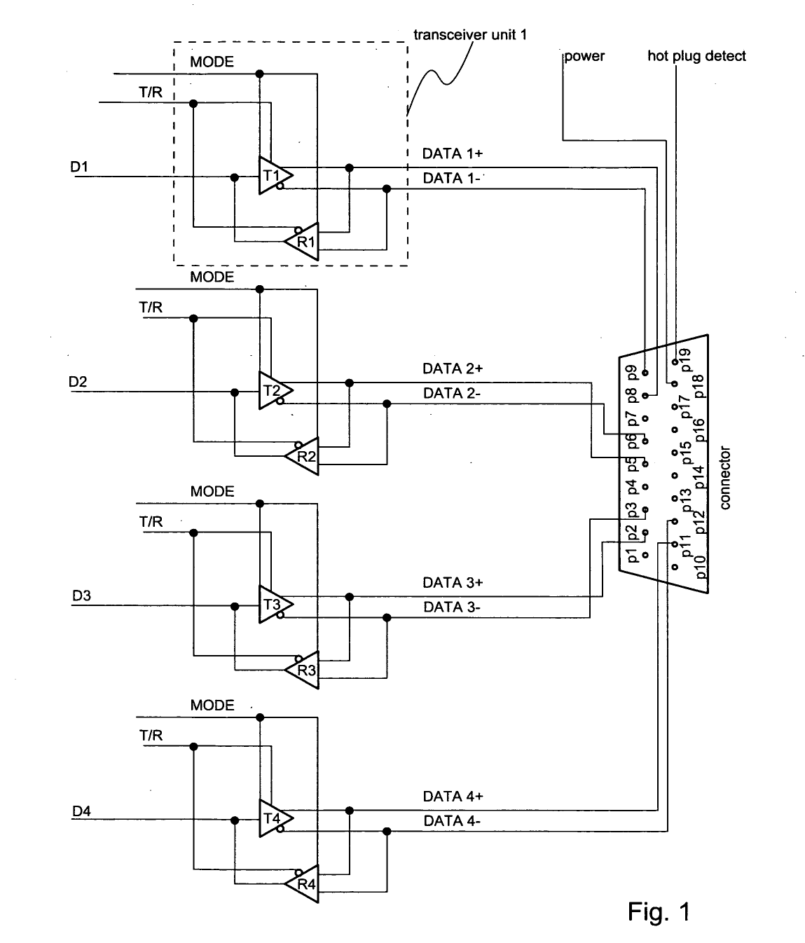

FIG. 1 shows one embodiment of a combined connection interface according to the invention. The interface includes at least eight data lines Data1+/Data1− to Data 4+/Data4−. The data lines are logically arranged in pairs; to increase noise immunity, a line pair may be arranged close together or e.g. as a twisted pair. Further data lines may be present, such as shield lines for each of the line pairs, control and status lines, or any other lines necessary. Each line pair is used for transmitting and receiving differential signals and to this end connected to both a transmitter (T1 to T4) and a receiver element (R1 to R4). Behind each transmitter/receiver T/R, a single data line D1 to D4 conveys the differentially transmitted signal for further processing in the device (or is fed into the receiver from the device for transmission).

The invention is not necessarily restricted to a single data line for each T/R. In an exemplary embodiment they are not combined and there are 2 lines for each T/R: a D1 in and D1 out etc. This may include the case of later combining the In/Out signals in the circuit.

The above mentioned combination of four differential signals is for example used in HDMI. Each line pair forms a channel, with one channel transmitting a clock signal for frequency referencing, while audio data, video data and auxiliary data (such as content right protection, signaling data, etc.) is transmitted via the remaining three channels. Transmission is achieved according to the TMDS scheme (transition minimized differential signaling). TMDS reduces electromagnetic interference caused by bit transitions in the serialized data. A bit transition is the change from 1 to 0 or vice versa within the serial code word to be transmitted. In TMDS, an encoding algorithm is used to minimize such transitions within an 8-bit code word, and a further bit is added to indicate that transition minimizing encoding was performed. However, the invention is not limited to this special signaling format and could also be applied to various other differential signaling methods. Further details regarding the HDMI standard may e.g. be found in the HDMI specification, version 1.3, June 2006, which is herewith incorporated by reference.

Usually, a HDMI interface element is either designed as a receiver or a transmitter, and data communication is unidirectional. By utilizing exemplary embodiments of the invention, the communication direction may be switchable since both a transmitter T and a receiver element R are present, optionally embodied in a single transceiver circuit or semiconductor element. FIG. 1 shows as an example separate transmitter and receiver circuits. Data transmission lines Data1+/Data1− to Data4+/Data4− are fed in pairs into the receiver as an input, and are also connected to a non-inverted and an inverted output of the transmitter.

Each of these four transceiver arrangements with differential transmission lines may not only be used and processed together such as in HDMI signaling, but also separately. Any transceiver group and the corresponding data lines can thus also be used for signaling according to the USB standard. This allows for a single interface providing data transmission according to different transmission schemes and standards, such as in an exemplary embodiment, for both USB and HDMI data transmission. For switching between operating modes of the interface, each combined transceiver unit is further provided with a mode signal and a transmit/receive signal. This may for example be implemented by a binary signal, with a value of 1 indicating a HDMI/DVI operating mode and a value of 0 indicating USB mode (or vice versa). The transmit/receive signal could then be used to switch between transmitter mode and receiver mode for the HDMI/DVI operating mode, while such a distinction would not be necessary in USB mode due to the bi-directional nature of USB signaling. Thus, three operating modes are available in this exemplary embodiment of an inventive combined connection interface:
MODE=0, T/R=1 or 0: up to four independent USB lines
MODE=1, T/R=0: one HDMI/DVI transmitter
MODE=1, T/R=1: one HDMI/DVI receiver

Using the MODE control signal, the reference voltage for the transmitter or the receiver, respectively, may be selected to comply with the desired transmission standard. Similarly, the transmit/receive signal T/R may be used for switching the data line to either the input of the transmitter element or the output of the receiver element. In alternative embodiments, this signal may directly activate and deactivate either one of both transceiver elements (transmitter or receiver). Optionally, a default mode could be predetermined in a module or device using the connection interface, such that a device would always be in a certain mode (e.g. USB mode) unless a detection condition is met. Design and pin arrangement of the connector shown in the figure should only be regarded as descriptive and may deviate in an actual embodiment of the invention. In particular, according to some embodiments of the invention the design, connection and pin arrangement may be implemented according to one of the connector types of the HDMI specification v1.3. Further control signals may be used to configure other and/or additional elements of a transceiver circuit. Although several pins are not shown to be connected in FIG. 1, some or all of them may be provided with further connections to the device for control, grounding, power supply or other purposes.

As shown above, in an exemplary embodiment, one operating mode may provide up to four independent USB transmission channels and connections. Thus, a plug or adapter could be used to connect one or more USB devices to the HDMI type combined connection interface. Such an adapter will be described in more detail below. In HDMI/DVI mode, a single HDMI plug, that is, a HDMI compatible connector, which may also be some proprietary connector not complying with standard HDMI mechanics specifications, but operating according to the same signaling scheme, may be connected to the interface. To ensure that correct decoding and encoding schemes as well as necessary voltages are used for any attached device, a detection scheme is necessary.

When a device, plug or adapter is plugged into the combined connection interface, a status of some line or a certain signal sequence may be utilized to recognize the respective transmission standard. While various such detection criterions are conceivable to the person skilled in the art, some possible implementations will be given by way of example here.

One possibility is to use a hot plug detection scheme as known from HDMI. One line/pin of the connector may be reserved for a detection signal. During the initiation process of HDMI, a high voltage level is asserted on this line or pin. The correspondent device may detect that the voltage on this line is within a certain range and thus determines that a HDMI capable device is connected. In USB, this signal is not used and may thus serve as a distinction feature.

In another embodiment, a signal sequence provided on a control channel or control line may be used to detect the presence of a device using a specific transmission protocol. For HDMI compatible devices, a control channel is formed of three lines (SCL, SDA and DDC/CEC ground). Control signals are transmitted on this channel in accordance with the I2C bus protocol. The device may be able to detect and analyze these control signals and thus conclude the presence of a HDMI device when the correct signal sequence is detected.

In any case, the detection procedure may be controlled and/or performed by a logic circuit or alternatively by a software module that is stored and executed on a processing unit or controller of the device having the combined connection interface.

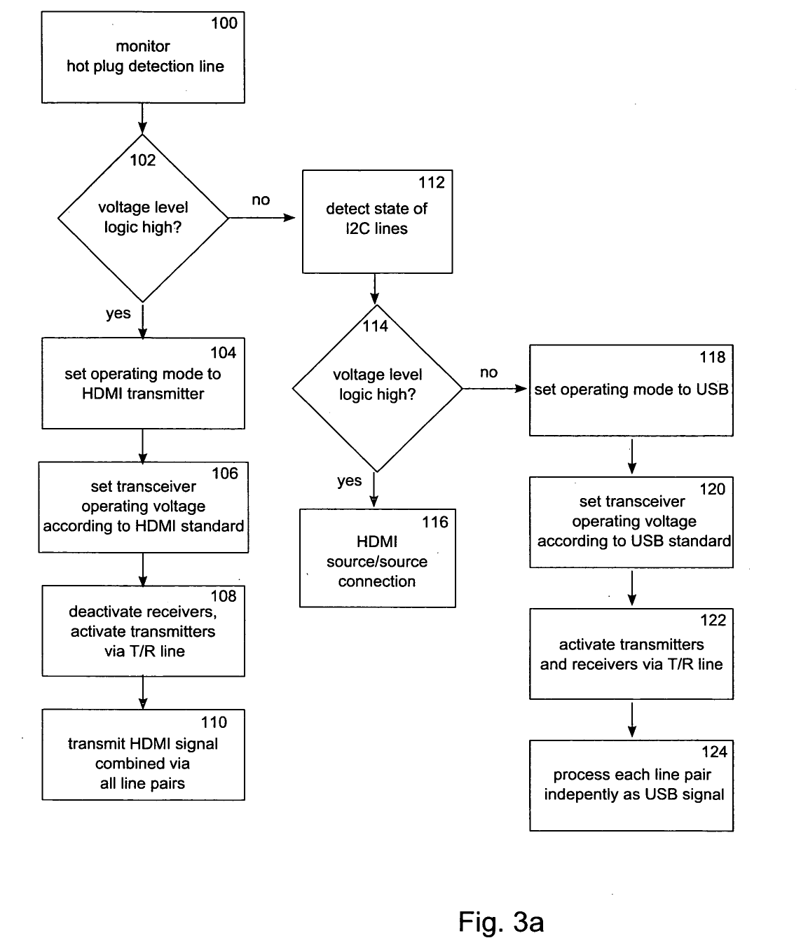

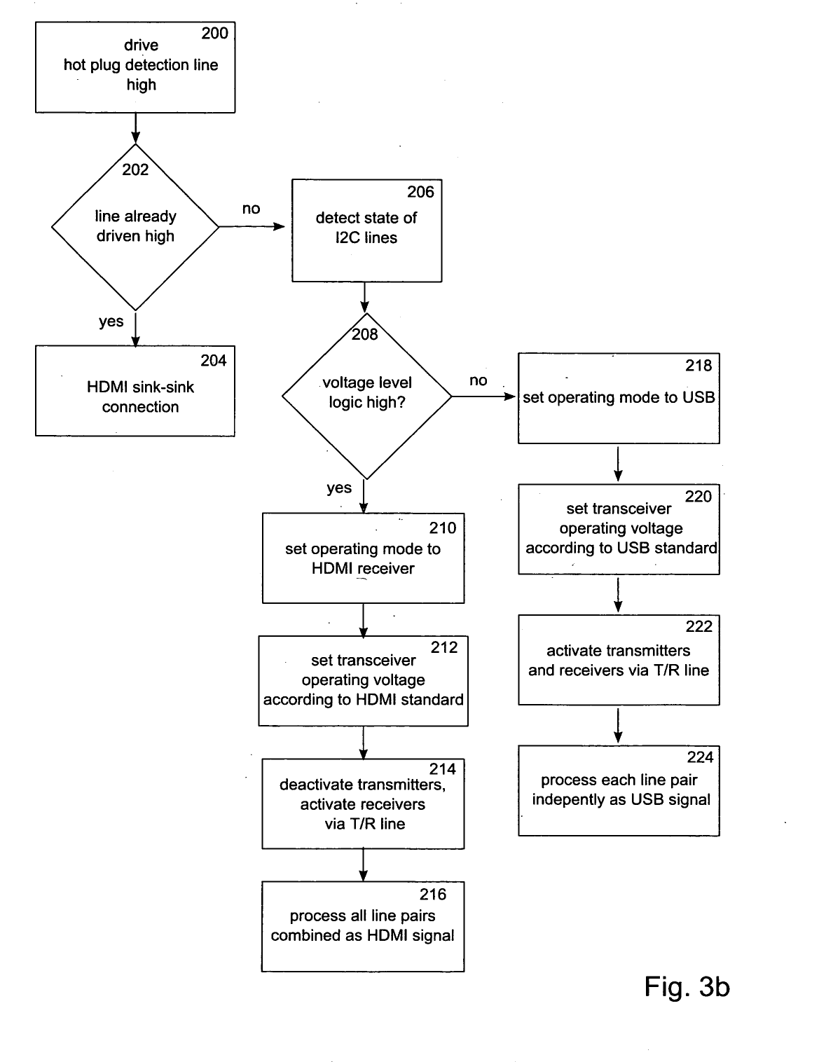

An example of a detection sequence is illustrated by the flow chart of FIG. 3a, where the detecting device acts as a source device. Here, the hot plug detection pin is taken as an exemplary detection method and monitored in step 100 by the detection circuit or a processor/controller. If a logic voltage high is detected in step 102, this indicates the presence of a HDMI sink (receiver) connected. Thus, the operating mode is set to HDMI transmitter in step 104, and the MODE line as shown in FIG. 1 is used to set the transceiver operating voltage to a value that is in accordance with the HDMI standard in step 106. The corresponding voltage value may be stored or preset at the transmitter/receiver itself. In step 108, the receivers on all line pairs may be deactivated (or disconnected), and the transmitters activated, both via the T/R control line also shown in FIG. 1. The set HDMI transmitter mode results in processing all data to be transmitted on the four line pairs together as a HDMI signal in step 110.

If the hot plug detection line is not asserted and shows a high impedance state, the I2C lines of the control channel are checked as well (step 112/114). Detection of a high (e.g. 5V) signal on these lines indicates a HDMI source device (step 116), while a high impedance signal (floating) on the I2C lines indicates a USB device connected. In the case of a USB device, the operating mode will be set to USB in step 118. Similarly to the case above, the transceiver operating voltage is set to a value that is in accordance with the USB standard in step 120. Then, the receivers and transmitters on all line pairs are activated for bi-directional USB transmission in step 122. Each line pair is processed independently as a USB signal in step 124. The case of a high signal on the I2C lines in step 114 and thus another source device may e.g. optionally lead to an error message being displayed, since both connected devices would act as sources. Alternatively, the detecting device may switch to act as a sink device. It may switch to a default application for acting as a sink device (e.g. video playback), or it may show the user a list of possible application for selection (e.g. a list showing video recording, video sending over WLAN and video playback etc.).

In another example, the device may be used as a receiver, initiated e.g. directly by a user or software. This is exemplarily shown in FIG. 3b. Acting as a sink, the device will drive the hot plug detection line high (step 200). If additionally a high common signal is detected on this line in step 202, this indicates a connection to another receiver (204). If this is not the case and a high (e.g. 5V) logic level is detected on the I2C line (steps 206/208), a HDMI source is indicated, while again a high impedance signal on these lines indicates a USB device. Again, voltages are set and receivers/transmitters are activated or deactivated in accordance with the detected operating mode, similar to the description of FIG. 3a above. That is, for a detected HDMI source the operating mode is set to HDMI receiver in step 210, and the operating voltage is set according to the HDMI standard in step 212. As the device should act as an receiver, the transmitters are deactivated in step 214 via the T/R line. Now transmission may take place with all received signals being processed as a HDMI signal combined on all four line pairs (step 216). Accordingly, the operating mode of the device is set to USB when the I2C line is not asserted (step 218). Receivers and transmitters are activated for bi-directional USB communication in step 222, while transceiver operating voltage is set according to the USB standard (step 220). Then, all incoming signals are processed independently for each line pair as USB signals in step 224.

If connection to another receiver is detected in step 204, the device may automatically switch to transmit mode as in FIG. 3a (102 and 104). If no application is selected, a default screen may be sent on the HDMI connection. This may be a user logo or the contents shown on the device's own screen.

The connector element as shown e.g. in FIG. 1 and described above is only given by way of example. Connector size, wiring structure and design may vary and include connector types A, B, and C as specified in the HDMI specification v1.3, as well as other connector types providing all necessary data inputs and outputs as described above. Small connectors, such as connector type C (also known as mini-HDMI), are particularly suitable for mobile and portable devices having limited space for connectors and interfaces. Also, due to the wide range of applications that are available with either HDMI (and DVI) or USB, a single small connector could be sufficient for most or all required video, audio, and data connections.

In a connector, additional lines/pins with additional functionalities may be provided. The data line pairs in a corresponding cable may be implemented e.g. as shielded pairs, each having a further shielding line (such as a braided shield around the wires). The shield pins as implemented in HDMI Type C connectors are shown in FIG. 1, where pins p1, p4, p7, and p10 would each lead to a shielding line (not shown) for the adjacent data line pair.

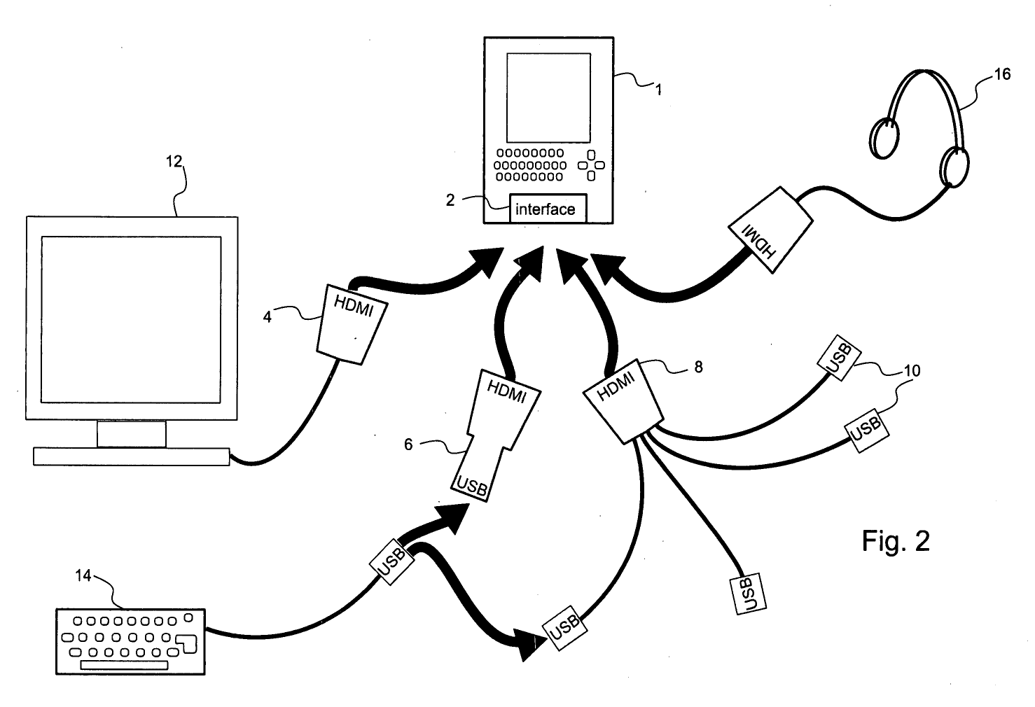

FIG. 2 illustrates some examples for connection possibilities according to various embodiments of the invention. Possible connections are indicated by arrows between the devices and adapters shown. A device 1 is provided with a multiplexed connection interface 2 according to embodiments of the invention, as described above. Such a device may be e.g. a portable device for multimedia play-back, a recording device, a communication device such as a mobile phone, or any other device that might benefit from a combined connector. This novel interface provides a wide range of possibilities for connecting other devices and applications. For example, an external display 12 having a HDMI input 4 may be directly connected to the combined interface, leading to identification of an HDMI device and selection of HDMI transmitter mode as described before. The external display may then be used to display media stored and/or received on the portable device. Since HDMI also supports the transport of audio data, there is no need for a further audio connector on the device, and units such as headphones, as well as a DVI-compliant display device or a HDMI compatible TV set, could easily be attached on the same combined connection interface via a HDMI plug. In case of the headphone this would require decoding of audio from HDMI packets in the headphone, but a benefit would be that copyright protection can be guaranteed also for audio in the headphone.

For HDMI mode both headphone and display represent sink devices. The present invention covers also a use of both receiver and transmitter over the same connector, so here also camcorders and DVD players (source devices) shall be mentioned as examples for HDMI sink devices.

As another option, a USB device such as a keyboard 14, a flash drive (not shown), or any other could be connected by using an adapter 6, 8 according to one aspect of the invention. This adapter may be a single channel adapter 6 which only connects one USB signaling pair to one of the HDMI type data line pairs, while the remaining pairs of the HDMI type connector are left floating or terminated in the adapter. Since at least four pairs of differential data lines are available on the interface of the invention, more than this one USB connector may be provided on another adapter 8 according to the invention. This allows the connection of four (on a 19-pin HDMI type interface) or even more USB devices to the device via the single multiplexed connection interface. As each USB device is connected to a single differential USB line, the USB devices do not have to share the data rate, as would be required if a plurality of USB devices were connected to a device via a USB hub. That is, the advantage of this USB implementation relies in that the data rate must not be shared. In a conventional USB hub one can connect several USB devices to a host device using only one USB cable. However, in this case, the multiple USB devices have to share the data rate. Instead of an external adapter, such a USB device 16 could optionally be equipped with a HDMI type connector, but still only use a single differential pair of the connector for transmission of a USB compliant signal. Implementing such a plug/connector still using USB protocol could be advantageous for power saving reasons or others. This corresponds to a simple HDMI/USB adapter integrated into the connector or cable of the device itself.

Furthermore, the number of differential line pairs integrated in the interface is not limited to four pairs as in the embodiment described above. For example, a type B HDMI connector as described in the HDMI specification v.1.3 provides a connection to three more line pairs (data channels) for enabling very high bandwidth video. Using such a connector, there could be additional operating modes, such as a combined mode comprising standard (four channel) HDMI operation as well as independent USB operation on the remaining three channels. In that case, control lines for mode selection (such as MODE and T/R mentioned above) may be controlled separately for some transceiver units.

It should be understood that the multiplexed connection interface allows using both HDMI transmitter and receiver functions with only one connector, while typically a HDMI device is either arranged as a source (transmitter) or sink (receiver). Also, implementation space and cost are reduced due to the fact that transceiver units are practically shared between the HDMI and the USB interface.

Although exemplary embodiments of the present invention have been described, these should not be construed to limit the scope of the appended claims. For example, the invention may also be applied to future versions of HDMI, USB and similar protocols that allow an operation as described. Those skilled in the art will understand that various modifications may be made to the described embodiments and that numerous other configurations or combinations of any of the embodiments are capable of achieving this same result. Moreover, to those skilled in the various arts, the invention itself will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention.

What is claimed is:

1. A method comprising:
monitoring at least one line of an interface comprising at least four differential data line pairs;
detecting signals indicative of the presence of a connected device at said interface;
selecting one of a predefined set of operating modes dependent on detected signals on said at least one monitored line; and
receiving and/or transmitting signals on at least one of said differential data line pairs, wherein said received signals and/or signals to be transmitted are processed in combination or independently for each data line pair, dependent on said selected operating mode.

2. The method of claim 1, further comprising:
applying an operating voltage dependent on said selected operating mode to at least one transmitter and at least one receiver both connected to one of said differential line pairs.

3. The method of claim 1, further comprising:
activating and/or deactivating at least one of said transmitters and receivers dependent on said selected operating mode.

4. The method of claim 1, wherein said predefined set of operating modes comprises at least a High Definition Multimedia Interface HDMI mode.

5. The method of claim 1, wherein said predefined set of operating modes comprises at least a Universal Serial Bus USB mode.

6. The method of claim 4, wherein said HDMI mode comprises a transmitter sub-mode and a receiver sub-mode.

7. The method of claim 6, further comprising, when operating in said HDMI transmitter sub-mode,
deactivating all receivers; and
activating all transmitters connected to said differential line pairs.

8. The method of claim 6, further comprising, when operating in said HDMI receiver sub-mode,
deactivating all transmitters; and
activating all receivers connected to said differential line pairs.

9. The method of claim 1, wherein said monitoring of at least one line further comprises:
receiving a signal sequence; and
comparing said signal sequence to a stored signal sequence.

10. The method of claim 1, wherein said monitoring of at least one line further comprises:
measuring a voltage level on at least one line; and
determining whether said measured voltage level is within a predetermined voltage range.

11. The method of claim 1, further comprising retrieving a stored default value for said operating voltage.

12. An interface comprising:
at least four transmitters and at least four receivers;
at least four differential pairs of data lines, wherein each line pair is connected to outputs of one of said transmitters and inputs of one of said receivers;
a detection unit capable of monitoring at least one line of said interface;
at least one control line connected to said transmitters and receivers, and arranged to set an operating mode of each of said transmitters and receivers responsive to a signal detected on said at least one monitored line; and
a processing unit connected to an input of said transmitters and to an output of said receivers, and arranged to process data received and/or transmitted via said four differential line pairs either combined or independently of each other, responsive to said detected signal.

13. The interface of claim 12, wherein said detection unit comprises logic circuitry.

14. The interface of claim 12, wherein said detection unit comprises a software module run on a processor or controller.

15. The interface of claim 12, further comprising a control channel connected to said detection unit, and wherein said detected signal is a signaling sequence received on said control channel.

16. The interface of claim 12, further comprising a dedicated detection line connected to said interface, and wherein said detected signal is a voltage level on said detection line.

17. The interface of claim 12, wherein said lines of said interface are configured to operate according to the signaling defined by the HDMI specification.

18. The interface of claim 12, wherein said interface is configured in accordance with the HDMI specification.

19. The interface of claim 12, wherein one of each said transmitters and one of each said receivers connected to one line pair are combined in a single transceiver unit.

20. An adapter comprising:
a first connector having at least eight input/output connections;
at least a second connector having at least two input/output connections;
at least one pair of data lines adapted for differential signaling, said pair of data lines being connected between said first connector and said at least one second connector.

21. The adapter of claim 20, comprising four second connectors, each one connected to a separate pair of data lines.

22. The adapter of claim 20, wherein said first connector is implemented in accordance with the High Definition Multimedia Interface standard.

23. The adapter of claim 20, wherein said at least one second connector is implemented in accordance with the Universal Serial Bus Standard.

24. A mobile communication device comprising a multiplexed connection interface, wherein said interface comprises:
at least four transmitters and at least four receivers;
at least four differential pairs of data lines, wherein each line pair is connected to outputs of one of said transmitters and inputs of one of said receivers;
a detection unit capable of monitoring at least one line of said interface;
at least one control line connected to said transmitters and receivers, and arranged to set an operating mode of each of said transmitters and receivers responsive to a signal detected on said at least one monitored line; and
a processing unit connected to an input of said transmitters and to an output of said receivers, and arranged to process data received and/or transmitted via said four differential line pairs either combined or independently of each other, responsive to said detected signal.

25. A computer program product that is configured to perform at least the following steps when executed on a computer or processing unit:
monitoring a signal on at least one line of an interface, said interface comprising at least four differential data line pairs;
detecting the presence of a connected device at said interface;
selecting one of a predefined set of operating modes dependent on said monitoring; and
receiving and/or transmitting signals on at least one of said differential data line pairs, wherein said received signals and/or signals to be transmitted are processed in combination or independently for each data line pair, dependent on said selected operating mode.

26. The computer program product according to claim 25, configured to perform the additional following steps when executed on a computer or processing unit:
transmitting a signal for applying an operating voltage dependent on said monitored signal to at least one transmitter and at least one receiver circuit connected to said differential data line pairs.

27. A device comprising:
means for monitoring at least one line of an interface, said interface comprising at least four differential data line pairs;
means for detecting signals indicative of the presence of a connected device at said interface;
means for selecting one of a predefined set of operating modes dependent on detected signals on said at least one monitored line; and
means for receiving and/or transmitting signals on at least one of said differential data line pairs, wherein said received signals and/or signals to be transmitted are processed in combination or independently for each data line pair, dependent on said selected operating mode.

28. Device according to claim 27, further comprising:
means for applying an operating voltage dependent on said selected operating mode to at least one transmitter and at least one receiver both connected to one of said differential line pairs.
